(19) United States
(12) Patent Application Publication
(10) Pub. No.: US 2019/0371503 A1
(43) Pub. Date: Dec. 5, 2019

(54) MAGNETIC COMPOSITE AND ELECTRONIC COMPONENT USING THE SAME

(71) Applicant: Murata Manufacturing Co., Ltd., Kyoto-fu (JP)

(72) Inventors: Kazutoshi SUGII, Nagaokakyo-shi (JP); Kenichi KATO, Nagaokakyo-shi (JP)

(73) Assignee: Murata Manufacturing Co., Ltd., Kyoto-fu (JP)

(21) Appl. No.: 16/419,838

(22) Filed: May 22, 2019

(30) Foreign Application Priority Data
Jun. 1, 2018 (JP) 2018-105988
Mar. 8, 2019 (JP) 2019-042703

(51) Int. Cl. H01F 1/34; H01F 17/04; H01F 27/29

(52) U.S. Cl. CPC H01F 1/344; H01F 27/29; H01F 17/04

(57) ABSTRACT

A magnetic composite contains a ferrite composition and zinc silicate. The ferrite composition is composed of a spinel ferrite and bismuth oxide present in the spinel ferrite, and the percentage by weight of bismuth oxide to the whole magnetic composite is about 0.025% by weight or more and about 0.231% by weight or less (i.e., from about 0.025% by weight to about 0.231% by weight). The percentage by weight of zinc silicate based on the total weight of zinc silicate and the spinel ferrite is about 8% by weight or more and about 76% by weight or less (i.e., from about 8% by weight to about 76% by weight).

### CROSS-REFERENCE TO RELATED APPLICATIONS

This application claims benefit of priority to Japanese Patent Application No. 2018-105988, filed Jun. 1, 2018, and to Japanese Patent Application No. 2019-042703, filed Mar. 8, 2019, the entire content of each is incorporated herein by reference.

### BACKGROUND

### Technical Field

The present disclosure relates to a magnetic composite and an electronic component using the magnetic composite.

### Background Art

Magnetic composites, containing a magnetic material and a nonmagnetic material, have been used as materials for the body of multilayer coil components for removing high-frequency noise from an electronic device.

Japanese Unexamined Patent Application Publication No. 2016-196398 describes a composite ferrite composition containing a magnetic material and a nonmagnetic material. The magnetic material is a Ni—Cu—Zn ferrite, and the nonmagnetic material contains a low-dielectric-constant nonmagnetic material and bismuth oxide. The low-dielectric-constant nonmagnetic material is represented by the general formula (a(bZnO·cCuO)·SiO₂, where a=1.5 to 2.4, b=0.85 to 0.98, and c=0.02 to 0.15 (and b+c=1.00). The mixing ratio between the magnetic material and the low-dielectric-constant nonmagnetic material is between 80% by weight:20% by weight and 10% by weight:90% by weight.

### SUMMARY

After research, the inventors found that electronic components produced with a magnetic composite rich in bismuth oxide as a sintering agent tend to be lower in the electrical resistivity of their body and prone to defects, such as unwanted spread of plating. These defects affect the reliability of the electronic components.

Accordingly, the present disclosure provides a magnetic composite with which electronic components having a highly resistive body can be produced. An electronic component using this magnetic composite is also provided.

The inventors found that in the field of magnetic composites containing a bismuth oxide-containing ferrite composition as a magnetic material and zinc silicate as a nonmagnetic material, particular percentages of bismuth oxide ensure that the magnetic composite provides electronic components having a highly resistive body. The present disclosure was completed on the basis of these findings.

According to a first preferred embodiment of the present disclosure, a magnetic composite contains a ferrite composition and zinc silicate. The ferrite composition is composed of a spinel ferrite and bismuth oxide present in the spinel ferrite, and the percentage by weight of bismuth oxide to the whole magnetic composite is about 0.025% by weight or more and about 0.231% by weight or less (i.e., from about 0.025% by weight to about 0.231% by weight). The percentage by weight of zinc silicate based on the total weight of zinc silicate and the spinel ferrite is about 8% by weight or more and about 76% by weight or less (i.e., from about 8% by weight to about 76% by weight).

According to a second preferred embodiment of the present disclosure, an electronic component includes a body as a stack of a plurality of magnetic layers, outer electrodes on the outer surface of the body, a coil conductor inside the body, and extended conductors electrically coupling the outer electrodes and the coil conductor together. The body is made of the above magnetic composite.

By virtue of the above features, the magnetic composite according to an embodiment of the present disclosure provides electronic components having a highly resistive body.

Other features, elements, characteristics and advantages of the present disclosure will become more apparent from the following detailed description of preferred embodiments of the present disclosure with reference to the attached drawings.

### BRIEF DESCRIPTION OF THE DRAWINGS

FIG. 1 is a perspective view of an electronic component according to an embodiment of the present disclosure with the inside visible; and

FIG. 2 is a perspective view of an electronic component according to another embodiment of the present disclosure with the inside visible.

### DETAILED DESCRIPTION

The following describes embodiments of the present disclosure in detail with reference to the drawings. It is to be noted that the following embodiments are for illustration purposes and are not intended to limit the present disclosure.

Magnetic Composite

A magnetic composite according to this embodiment is a composite material that contains a ferrite composition and zinc silicate (willemite). The zinc silicate can be represented by a(bZn·cMO)SiO₂, where a is about 1.5 or more and about 2.4 or less (i.e., from about 1.5 to about 2.4), b is about 0.85 or more and about 1 or less (i.e., from about 0.85 to about 1), and c is about 0.00 or more and about 0.15 or less (i.e., from about 0.00 to about 0.15). M can be Cu.

The ferrite composition is composed of a spinel ferrite and bismuth oxide (Bi₂O₃) present in the spinel ferrite. The spinel ferrite can be, for example, a Ni—Cu—Zn ferrite, a Mn—Cu—Zn ferrite, or a Ni—Mn—Cu—Zn ferrite. The spinel ferrite gives the magnetic composite good high-frequency characteristics. The chemical makeup of the spinel ferrite is not critical and can be selected as appropriate for the intended purpose. The spinel ferrite may contain one or more selected from Co, Mn, and Sn. Ni—Cu—Zn ferrites, by way of example, may each contain about 1 ppm or more and about 200 ppm or less (i.e., from about 1 ppm to about 200 ppm) of Co, about 1 ppm or more and about 3000 ppm or less (i.e., from about 1 ppm to about 3000 ppm) of Mn, and about 1 ppm or more and about 1000 ppm or less (i.e., from about 1 ppm to about 1000 ppm) of Sn. Mn—Cu—Zn and Ni—Mn—Cu—Zn ferrites may each contain about 1 ppm or more and about 200 ppm or less (i.e., from about 1 ppm to about 200 ppm) of Co and about 1 ppm or more and about 1000 ppm or less (i.e., from about 1 ppm to about 1000 ppm) of Sn.

The bismuth oxide works as a sintering agent, which helps sinter the magnetic composite. In a magnetic composite according to this embodiment, the bismuth oxide is present inside the spinel ferrite, more specifically in the boundaries between crystal grains of the ferrite. By virtue of being present inside the spinel ferrite, the bismuth oxide helps sinter the magnetic composite in a smaller amount. Besides the inside of the spinel ferrite, the magnetic composite may contain a trace amount of bismuth oxide on the surface of and outside the spinel ferrite. In this case, the percentage by weight of the bismuth oxide present inside the spinel ferrite is preferably more than about 50% by weight with respect to the total weight of bismuth oxide in the magnetic composite.

The percentage by weight of bismuth oxide to the whole magnetic composite is about 0.025% by weight or more and about 0.231% by weight or less (i.e., from about 0.025% by weight to about 0.231% by weight), preferably 0.036% by weight or more and about 0.21% by weight or less (i.e., from 0.036% by weight to about 0.21% by weight). Bismuth oxide present in a percentage equal to or more than about 0.025% by weight, preferably equal to or more than about 0.036% by weight, makes the magnetic composite more sinterable and less water-absorbent. A weight percentage of bismuth oxide equal to or less than about 0.231% by weight, preferably equal to or less than about 0.21% by weight, will ensure a high resistivity of about 9 log Ω·cm or more.

The bismuth oxide content of the magnetic composite can instead be expressed as a percentage by weight of bismuth oxide to the spinel ferrite. In this case, the percentage by weight of bismuth oxide to the ferrite composition is about 0.1% by weight or more and about 0.25% by weight or less (i.e., from about 0.1% by weight to about 0.25% by weight), preferably about 0.15% by weight or more and about 0.25% by weight or less (i.e., from about 0.15% by weight to about 0.25% by weight). A weight percentage of bismuth oxide within these ranges leads to improved sinterability of the magnetic composite and will ensure a high resistivity of about 9 log Ω·cm or more.

When the relative amounts of zinc silicate and the spinel ferrite are expressed as weight percentages, the percentage by weight of zinc silicate is about 8% by weight or more and about 76% by weight or less (i.e., from about 8% by weight to about 76% by weight) with respect to the total weight of zinc silicate and the spinel ferrite. Too high a weight percentage of the nonmagnetic zinc silicate would cause low magnetic permeability and high water absorbency of the magnetic composite. The opposite, too low a weight percentage of zinc silicate, would cause poor characteristics under superimposed direct current (DC characteristics). Weight percentages of zinc silicate and the spinel ferrite satisfying the above condition will ensure high magnetic permeability combined with good DC characteristics and low water absorbency of the magnetic composite.

The relative amounts of zinc silicate and the spinel ferrite can alternatively be expressed as volume percentages. In this case, the percentage by volume of zinc silicate is about 10% by volume or more and about 80% by volume or less (i.e., from about 10% by volume to about 80% by volume) with respect to the total volume of zinc silicate and the spinel ferrite. Such volume percentages of zinc silicate and the spinel ferrite will ensure high magnetic permeability combined with good DC characteristics and low water absorbency of the magnetic composite.

If the relative amounts of zinc silicate and the spinel ferrite are expressed as weight percentages, the percentage by weight of zinc silicate is preferably about 8% by weight or more and about 25% by weight or less (i.e., from about 8% by weight to about 25% by weight) with respect to the total weight of zinc silicate and the spinel ferrite. If the relative amounts of zinc silicate and the spinel ferrite are expressed as volume percentages, the percentage by volume of zinc silicate is preferably about 10% by volume or more and about 30% by volume or less (i.e., from about 10% by volume to about 30% by volume) with respect to the total volume of zinc silicate and the spinel ferrite. Such relative amounts of zinc silicate and the spinel ferrite will ensure a higher magnetic permeability of about 10 H/m or more.

Preferably, the magnetic composite contains no borosilicate glass. The magnetic composite in this case may consist solely of the ferrite composition and zinc silicate, with the proviso that the magnetic composite may further contain traces of unavoidable impurities, such as impurities originally present in its raw materials or coming from other substances used during production, such as a dispersant, a binder, and a plasticizer. In fabricating electronic components with a body made of a magnetic composite according to this embodiment in the way described hereinafter, the multilayer compacts may be barrel-finished with water before being fired into bodies. Multilayer compacts made from a magnetic composite containing borosilicate glass can release their glass component during this barrel finishing with water, and if this occurs, the resulting bodies can vary in sinterability. A magnetic composite free from borosilicate glass can never release a glass component while multilayer compacts made therefrom are barrel-finished with water. Eliminating borosilicate glass therefore helps prevent varying sinterability of bodies.

Eliminating borosilicate glass from the magnetic composite also helps increasing the strength (flexural strength) of bodies made from the magnetic composite. The increased strength can improve the reliability of electronic components made with the bodies by preventing the electronic components from cracking during mounting on a substrate.

Without wishing to be bound by a particular theory, the inventors presume that eliminating borosilicate glass from a magnetic composite can improve the strength of bodies made from the magnetic composite through the following mechanism. A magnetic composite containing a glass component unavoidably retains glass in boundaries between its grains. The glass in grain boundaries causes the magnetic composite to break there (or makes intergranular fractures more likely to occur), thereby affecting the strength of bodies made from the magnetic composite. With a magnetic composite containing no glass component, by contrast, such an embrittlement can never occur because there is no glass as an intergranular component. Grains of a glass-free magnetic composite, moreover, are unlikely to grow in size during firing. Bodies made from such a magnetic composite therefore contain few coarse grains; indeed, they are aggregates of fine grains. The resulting frequent necking between grains, the inventors believe, improves the strength of bodies made from the magnetic composite. The small percentage of coarse particles means, furthermore, that any cracks in the bodies tend to be nonlinear and short in length. This also appears to contribute to improved strength of the bodies.

The following describes the production of a magnetic composite according to this embodiment. It should be understood that the following is merely an example and not the only method for producing a magnetic composite according to this embodiment.

A spinel ferrite powder and bismuth oxide are weighed out and mixed to make the percentage by weight of bismuth oxide about 0.1% by weight or more and about 0.25% by weight or less (i.e., from about 0.1% by weight to about 0.25% by weight) with respect to the total weight of the spinel ferrite powder and bismuth oxide. The resulting mixture is calcined at temperatures between about 600° C. and about 800° C. The resulting ferrite composition powder and a zinc silicate powder are weighed out and mixed to make the percentage by weight of zinc silicate about 8% by weight or more and about 76% by weight or less (i.e., from about 8% by weight to about 76% by weight) with respect to the total weight of zinc silicate and the spinel ferrite. The resulting mixture is slurried with materials such as purified water, a dispersant, a binder, and/or a plasticizer through dispersion and milling, for example using a ball mill. The resulting slurry is shaped, for example by doctor blading, and the resulting compact is fired at temperatures between about 880° C. and about 930° C. This gives a magnetic composite according to this embodiment. The relative amounts of the raw-material spinel ferrite powder, bismuth oxide, and zinc silicate oxide powder are substantially the same as those of the spinel ferrite, bismuth oxide, and zinc silicate in the resulting magnetic composite.

Electronic Component

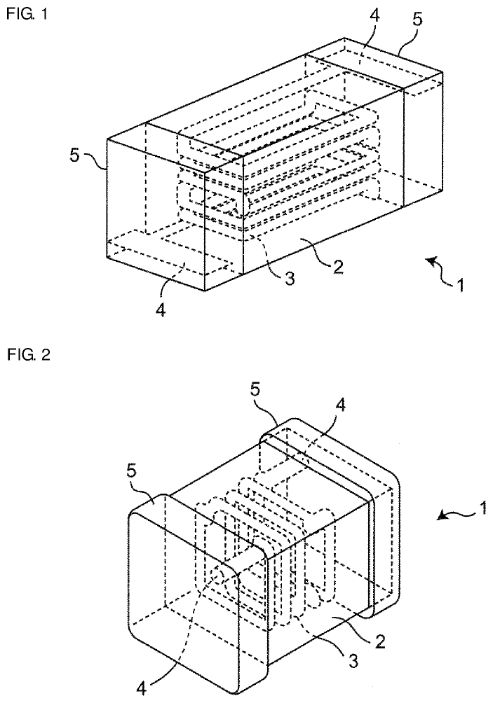

The following describes an electronic component according to an embodiment of the present disclosure. FIG. 1 illustrates an example of an electronic component according to this embodiment. The electronic component 1 in FIG. 1 is a multilayer coil component. The electronic component 1 according to this embodiment includes a body 2 as a stack of multiple magnetic layers, outer electrodes 5 on the outer surface of the body 2, a coil conductor 3 inside the body 2, and extended conductors 4 electrically coupling the outer electrodes 5 and the coil conductor 3 together. The body 2 is made of a magnetic composite according to an embodiment of the present disclosure. An electronic component according to this embodiment may have a structure as in FIG. 1, called vertical winding, or a structure as in FIG. 2, called horizontal winding. Electronic components according to this embodiment have a highly resistive body.

The production of multilayer coil components as electronic components according to this embodiment is through, for example, the following process. First, a spinel ferrite powder and bismuth oxide are weighed out and mixed to make the percentage by weight of bismuth oxide about 0.1% by weight or more and about 0.25% by weight or less (i.e., from about 0.1% by weight to about 0.25% by weight) with respect to the total weight of the spinel ferrite powder and bismuth oxide. The resulting mixture is calcined at temperatures between about 600° C. and about 800° C. The resulting ferrite composition powder and a zinc silicate powder are weighed out and mixed to make the percentage by weight of zinc silicate about 8% by weight or more and about 76% by weight or less (i.e., from about 8% by weight to about 76% by weight) with respect to the total weight of zinc silicate and the spinel ferrite. The resulting mixture is slurried with materials such as purified water, a dispersant, a binder, and/or a plasticizer through dispersion and milling, for example using a ball mill. The resulting slurry is shaped, for example by doctor blading, into sheets of a predetermined thickness. These sheets are perforated with via holes at predetermined points by laser irradiation, and the via holes are filled with an electrically conductive paste. Then the electrically conductive paste is applied to the sheets by screen printing to form patterns for the coil conductor and extended conductors.

The sheets with conductor patterns thereon are stacked in a predetermined order, and the stack is sandwiched from top and bottom between sheets having no conductor pattern. The stacked sheets are joined together by heat and pressure bonding, and the resulting structure is divided, for example with a dicer, into separate multilayer compacts. These multilayer compacts, optionally after being rounded at their corners by barrel finishing with water, are fired at temperatures between about 880° C. and about 930° C. to give bodies with a coil conductor inside. An electrically conductive paste for outer electrodes is applied to the outer surface of these bodies and baked at about 900° C. to form outer electrodes. The outer electrodes may optionally be plated. In this way, electronic components according to this embodiment are obtained.

It is to be noted that the multilayer coil components illustrated in FIGS. 1 and 2 are not the only possible forms of electronic components according to this embodiment. An electronic component according to this embodiment may instead be, for example, a composite electronic component including a coil and another element, such as a capacitor. An example is an LC component.

### EXAMPLES

Samples of Examples 1 to 10 and Comparative Examples 1 to 9 were prepared as follows. First, a spinel ferrite powder and bismuth oxide were weighed out and mixed to make the percentage by weight of bismuth oxide based on the total weight of the spinel ferrite powder and bismuth oxide as in Table 1. The resulting mixture was calcined at temperatures between about 600° C. and about 800° C. The resulting ferrite composition powder and a powder of a nonmagnetic material, specified in Table 1, were weighed out and mixed to make the percentage by weight of the nonmagnetic material powder based on the total weight of the nonmagnetic material powder and the spinel ferrite as in Table 1. The resulting mixture was slurried with materials such as purified water, a dispersant, a binder, and a plasticizer through dispersion and milling using a ball mill. In Comparative Examples 8 and 9, the mixture was dispersed and milled with borosilicate glass as an extra material. The amount of borosilicate glass was as in Table 1, in percentage by weight with respect to the total weight of the nonmagnetic material powder and the spinel ferrite. The resulting slurry was shaped by doctor blading into a sheet about 50-μm thick. Substantially rectangular die-cuts of the sheet were stacked and joined together by pressure bonding into a multilayer block. Ring-shaped die-cuts of this multilayer block were fired at about 920° C. for about 7 hours. In this way, ring-shaped samples each measuring about 12 mm in inner diameter, about 20 mm in outer diameter, and about 1 mm in thickness were prepared.

TABLE 1

| | | Nonmagnetic | | | | |
|---|---|---|---|---|---|---|
| | | material | | Bi₂O₃ (% by weight) | | Borosilicate |
| | Nonmagnetic | (% by | (% by | (to spinel | (to magnetic | glass |
| | material | volume) | weight) | ferrite) | composite) | (% by weight) |
| Comparative | Zinc silicate | 20 | 16 | 0 | 0 | 0 |
| Example 1 | | | | | | |
| Example 1 | Zinc silicate | 20 | 16 | 0.1 | 0.084 | 0 |
| Example 2 | Zinc silicate | 20 | 16 | 0.15 | 0.126 | 0 |
| Example 3 | Zinc silicate | 20 | 16 | 0.25 | 0.210 | 0 |
| Comparative | Zinc silicate | 20 | 16 | 0.35 | 0.294 | 0 |
| Example 2 | | | | | | |
| Comparative | — | 0 | 0 | 0.15 | 0.150 | 0 |
| Example 3 | | | | | | |
| Example 4 | Zinc silicate | 10 | 8 | 0.15 | 0.138 | 0 |
| Example 5 | Zinc silicate | 30 | 25 | 0.15 | 0.113 | 0 |
| Example 6 | Zinc silicate | 40 | 34 | 0.15 | 0.099 | 0 |
| Example 7 | Zinc silicate | 50 | 44 | 0.15 | 0.084 | 0 |
| Example 8 | Zinc silicate | 60 | 54 | 0.15 | 0.069 | 0 |
| Example 9 | Zinc silicate | 70 | 64 | 0.15 | 0.054 | 0 |
| Example 10 | Zinc silicate | 80 | 76 | 0.15 | 0.036 | 0 |
| Comparative | Zinc silicate | 90 | 87 | 0.15 | 0.020 | 0 |
| Example 4 | | | | | | |
| Comparative | Aluminum | 20 | 16 | 0.15 | 0.126 | 0 |
| Example 5 | oxide | | | | | |
| Comparative | Silicon oxide | 20 | 16 | 0.15 | 0.126 | 0 |
| Example 6 | | | | | | |
| Comparative | Cordierite | 20 | 16 | 0.15 | 0.126 | 0 |
| Example 7 | | | | | | |
| Comparative | Zinc silicate | 20 | 16 | 0.1 | 0.084 | 0.3 |
| Example 8 | | | | | | |
| Comparative | Zinc silicate | 20 | 16 | 0.1 | 0.084 | 0.5 |
| Example 9 | | | | | | |

The samples of Examples 1 to 10 and Comparative Examples 1 to 9 were tested as follows.

Relative Density

For each Example of Comparative Example, a sample was tested for sinterability by determining its relative density, defined as the percentage of measured as-sintered density to the theoretical density, from an as-sintered density measured by the method of Archimedes. The results are presented in Tables 2 and 3.

Water Absorbency

For each of Examples 1 to 10 and Comparative Examples 1 to 9, three samples were immersed in purified water for about 30 minutes. The surface of removed samples was dried with a paper wiper, and the samples were weighed. The percentage change in weight from before to after immersion was calculated as a measure of water absorbency. The results are presented in Tables 2 and 3.

Magnetic Permeability μ′

For each of Examples 1 to 10 and Comparative Examples 1 to 7, the magnetic permeability μ′ of five ring-shaped samples was measured using Agilent magnetic material test fixture (model number, 16454A) and impedance analyzer (model number, E4991A) at about 10 MHz and averaged. The results are presented in Tables 2 and 3.

Characteristics under Superimposed Direct Current

A wire was wound around a ring-shaped sample with about 60 turns, and direct current was applied using Agilent 4284A LCR meter. The calculated applied magnetic field and permeability were monitored to determine the applied magnetic field at which there was an about 10% decrease from the initial permeability. The results are presented in Tables 2 and 3.

Electrical Resistivity

A disk-shaped sample about 10 mm in diameter was coated on both sides with In—Ga. The resistance at about 50 V was measured using R8340A resistance meter with probes on both sides of the sample, and the resistivity was calculated from the dimensions of a single sheet. The results are presented in Tables 2 and 3.

Flexural Strength

For Example 1 and Comparative Examples 8 and 9, the flexural strength of samples was measured. First, samples for the measurement of flexural strength were prepared as follows. For each of Example 1 and Comparative Examples 8 and 9, slurry was prepared as in the method described above. The slurry was shaped by doctor blading into a sheet about 50-μm thick. The sheet was cut into pieces of predetermined size, and a predetermined number of the sheets were stacked. The resulting stacks were fired at about 920° C. for about 7 hours. In this way, samples of Example 1 and Comparative Examples 8 and 9 were obtained (size: about 30 mm×about 4 mm×about 0.8 mm thick). The flexural strength of the resulting samples was measured by three-point bending testing in accordance with JIS R1601 using Shimadzu Autograph universal tester (n=20 for each of Example 1 and Comparative Examples 8 and 9), and the measurements were averaged. The results are presented in Table 3.

TABLE 2

| | | Water | Magnetic | DC | |
|---|---|---|---|---|---|
| | Relative | absor- | perme- | character- | Electrical |
| | density | bency | ability | istics | resistivity |
| | (%) | (%) | (H/m) | (A/m) | (logΩ · cm) |
| Comparative | 85.9 | 2.64 | 12.4 | 4568 | 8.1 |
| Example 1 | | | | | |
| Example 1 | 95.1 | 0.44 | 14.2 | 3930 | 10.2 |
| Example 2 | 97.8 | 0.16 | 14.3 | 3733 | 9.7 |
| Example 3 | 95.5 | 0.40 | 13.8 | 4119 | 10.2 |
| Comparative | 97.3 | 0.20 | 14.0 | 4107 | 8.6 |
| Example 2 | | | | | |
| Comparative | 98.9 | 0.05 | 75.0 | 503 | 10.3 |
| Example 3 | | | | | |
| Example 4 | 98.0 | 0.07 | 19.3 | 2715 | 10.1 |
| Example 5 | 98.1 | 0.08 | 10.5 | 5039 | 10.1 |
| Example 6 | 97.8 | 0.10 | 7.5 | 6960 | 10.1 |
| Example 7 | 96.0 | 0.40 | 5.2 | 10301 | 9.8 |
| Example 8 | 95.7 | 0.35 | 3.8 | 13106 | 10.0 |
| Example 9 | 95.5 | 0.45 | 2.5 | 15553 | 10.1 |
| Example 10 | 95.2 | 0.47 | 1.7 | 18025 | 9.9 |
| Comparative | 94.1 | 0.60 | 1.2 | 19984 | 9.7 |
| Example 4 | | | | | |
| Comparative | 60.5 | 12.72 | 6.4 | 5238 | — |
| Example 5 | | | | | |
| Comparative | 80.5 | 3.72 | 7.3 | 5210 | — |
| Example 6 | | | | | |
| Comparative | 66.1 | 9.5 | 7.6 | 4592 | — |
| Example 7 | | | | | |

TABLE 3

| | Relative | Water | Magnetic | DC | Electrical | Flexural |
|---|---|---|---|---|---|---|
| | density | absorbency | permeability | characteristics | resistivity | strength |
| | (%) | (%) | (H/m) | (A/m) | (logΩ · cm) | (MPa) |
| Example 1 | 95.1 | 0.44 | 14.2 | 3930 | 10.2 | 273 |
| Comparative | 96.4 | 0.26 | 13.9 | 3912 | 10.2 | 237 |
| Example 8 | | | | | | |
| Comparative | 98.5 | 0.06 | 13.9 | 3884 | 10.4 | 231 |
| Example 9 | | | | | | |

Comparative Example 1, in which no bismuth oxide was used, was low in relative density (defined as about 95% or less; the same applies hereinafter), high in water absorbency (defined as about 0.5% or more; the same applies hereinafter), and low in resistivity (defined as about 9 log Ω·cm or less; the same applies hereinafter). Comparative Example 2, in which the percentage by weight of bismuth oxide was greater than about 0.25% by weight with respect to the weight of the ferrite composition, was low in resistivity. Comparative Example 3, in which no nonmagnetic material was used, was poor in DC characteristics. Comparative Example 4, in which the percentage by weight of zinc silicate was greater than about 76% by weight, was low in relative density and high in water absorbency. Comparative Example 5, in which the nonmagnetic material was alumina (Al₂O₃) instead of zinc silicate, was low in relative density and high in water absorbency. Comparative Example 6, in which the nonmagnetic material was silica (SiO₂) instead of zinc silicate, was low in relative density and high in water absorbency. Comparative Example 7, in which the nonmagnetic material was cordierite (2MgO.2Al₂O₃.5SiO₂) instead of zinc silicate, was low in relative density and high in water absorbency.

Comparative Examples 8 and 9, in which the magnetic composite contained borosilicate glass, was low in flexural strength, less than about 250 MPa. As can be seen from Table 3, the flexural strength decreased with increasing percentage of borosilicate glass.

Examples 1 to 10 were high in relative density and low in water absorbency compared with Comparative Examples 1 to 7. In Examples 1 to 10, furthermore, the DC characteristics were also better than in Comparative Examples 1 to 7, and the resistivity was higher than about 9 log Ω·cm.

Moreover, Example 1, in which no borosilicate glass was used, achieved a higher flexural strength than Comparative Examples 8 and 9, in which the magnetic composite contained borosilicate glass. The flexural strength in Example 1 was good, higher than about 250 MPa.

The present disclosure includes, but is not limited to, the following aspects.

### Aspect 1

A magnetic composite including a ferrite composition and zinc silicate, wherein:

the ferrite composition is composed of a spinel ferrite and bismuth oxide present in the spinel ferrite, and a percentage by weight of bismuth oxide to the whole magnetic composite is about 0.025% by weight or more and about 0.231% by weight or less (i.e., from about 0.025% by weight to about 0.231% by weight); and

a percentage by weight of zinc silicate based on a total weight of zinc silicate and the spinel ferrite is about 8% by weight or more and about 76% by weight or less (i.e., from about 8% by weight to about 76% by weight).

### Aspect 2

The magnetic composite according to Aspect 1, wherein the percentage by weight of zinc silicate based on the total weight of zinc silicate and the spinel ferrite is about 8% by weight or more and about 25% by weight or less (i.e., from about 8% by weight to about 25% by weight).

### Aspect 3

An electronic component including a body as a stack of a plurality of magnetic layers, outer electrodes on an outer surface of the body, a coil conductor inside the body, and extended conductors electrically coupling the outer electrodes and the coil conductor together, wherein

the body is made of a magnetic composite according to Aspect 1 or 2.

Electronic components fabricated using a magnetic composite according to an embodiment of the present disclosure are highly reliable and will find a wide range of applications by virtue of the high electrical resistivity of their body.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

What is claimed is:

1. A magnetic composite comprising a ferrite composition and zinc silicate, wherein:
the ferrite composition is composed of a spinel ferrite and bismuth oxide present in the spinel ferrite, and a percentage by weight of bismuth oxide to the whole magnetic composite is from about 0.025% by weight to about 0.231% by weight; and
a percentage by weight of zinc silicate based on a total weight of zinc silicate and the spinel ferrite is from about 8% by weight to about 76% by weight.

2. The magnetic composite according to claim 1, wherein the percentage by weight of zinc silicate based on the total weight of zinc silicate and the spinel ferrite is from about 8% by weight to about 25% by weight.

3. An electronic component comprising a body as a stack of a plurality of magnetic layers, outer electrodes on an outer surface of the body, a coil conductor inside the body, and extended conductors electrically coupling the outer electrodes and the coil conductor together, wherein
the body is made of a magnetic composite according to claim 1.

4. An electronic component comprising a body as a stack of a plurality of magnetic layers, outer electrodes on an outer surface of the body, a coil conductor inside the body, and extended conductors electrically coupling the outer electrodes and the coil conductor together, wherein
the body is made of a magnetic composite according to claim 2.

5. The magnetic composite according to claim 1, wherein the percentage by weight of bismuth oxide to the whole magnetic composite is from about 0.036% by weight to about 0.21% by weight.

6. The magnetic composite according to claim 2, wherein the percentage by weight of bismuth oxide to the whole magnetic composite is from about 0.036% by weight to about 0.21% by weight.

7. The magnetic composite according to claim 3, wherein the percentage by weight of bismuth oxide to the whole magnetic composite is from about 0.036% by weight to about 0.21% by weight.

8. The magnetic composite according to claim 4, wherein the percentage by weight of bismuth oxide to the whole magnetic composite is from about 0.036% by weight to about 0.21% by weight.
